(19) United States
(12) Patent Application Publication
(10) Pub. No.: US 2005/0279697 A1
(43) Pub. Date: Dec. 22, 2005

(54) Pipe filter and closure assembly

(76) Inventors: Mark Andrew Stephenson, Belmont (AU); Wayne Anthony Stephenson, Belmont (AU)

Correspondence Address: SEYFARTH SHAW LLP, 55 EAST MONROE STREET, SUITE 4200, CHICAGO, IL, 60603-5803, US

(21) Appl. No.: 10/513,112

(22) PCT Filed: May 2, 2003
(86) PCT No.: PCT/AU03/00520

§ 371 Date: May 27, 2005

(30) Foreign Application Priority Data
May 2, 2002 (AU) PS 2071

(51) Int. Cl. B01D 35/02

(52) U.S. Cl. 210/460; 210/462; 210/483; 210/499

(57) ABSTRACT

A pipe filter and closure assembly comprises a support member in the form of an annular collar or sleeve. In use the collar is positioned wholly within the pipe at some distance from an open (upper) end of the pipe. A filter element in the form of a strainer is releasably mountable to the collar so as to inhibit the passage of solid material through the pipe, whilst allowing the passage of fluids (liquids and gases) therethrough. A closure member in the form of a plug in use is mountable inside the collar to be seated at the strainer. In use when the plug is in place, the flow of material through the pipe is blocked. The location of the assembly or part thereof arrangeable wholly within the pipe reduces the ease of access to and presents significant difficulties for an operator seeking to tamper with the assembly.

### FIELD OF THE INVENTION

The present invention relates generally to plumbing, and more specifically to apparatus for use with open pipes for inhibiting the passage of objects including unwanted refuse therethrough. It will be convenient to hereinafter describe this invention with reference to this particular application, however it is to be understood this is not to be taken as a limitation as to the scope of the invention.

### BACKGROUND ART

Open pipes such as drains and the like are susceptible to the ingress of unwanted material which can lead to blockages. The situation is of particular concern during the construction of areas containing the pipe. For example, during the installation of a shower recess or a floor containing a drain, construction materials tend to fall into the drain. The known closure devices for pipes and drains are easily tampered with, often leading to environmentally unsound disposal of waste materials. Another problem which can occur in drains is where they become blocked. In such cases, undesirable smells may be created as a result of the blockage which tend to escape via the drain hole opening.

### SUMMARY OF THE INVENTION

In a first aspect the present invention provides a filter and/or closure assembly for use with a pipe, the assembly comprising:
a support member which is adapted in use for connection to and location wholly within the pipe;
a filter element releasably mountable to the support member so as to inhibit the passage of solid material through the pipe; and
a closure member mountable to the support member or the filter element for blocking the pipe.

In a second aspect the present invention provides a filter and/or closure assembly for use with a pipe, the assembly comprising:
a support member which in use is operatively connectible to the pipe;
a filter element releasably mountable to the support member so as to inhibit the passage of solid material through the pipe; and
a removable closure member mountable to the support member or the filter element for blocking the pipe,
   wherein the assembly is configured such that in use the filter element and the closure member are located wholly within the pipe.

When the term “blocking the pipe” is used it is to be understood that the closure member can block the pipe to the passage of materials therethrough in cooperation with the support member, which protrudes at least some radial distance into the pipe interior.

The invention defined in these aspects presents significant difficulties to an operator seeking to tamper with the assembly by trying to open the closure member in order to access the filter element. The location of at least some of the components of the assembly wholly within the pipe reduces the ease of access thereto.

Preferably the support member is adapted for connection around its periphery to the pipe interior, to be located remote from an end of the pipe. Preferably the support member is a collar. The collar may for example be secured in position by adhering with glue, the use of fasteners, welding or any other suitable technique. In another form the collar may be releasably secured by catches or pins or similar.

Preferably the support member comprises first and second collar sections of different diameter and which are disposed in end-to-end adjoinment with one another. Preferably a support shoulder is formed at an inner wall of the adjoining collar sections, in use to support the filter element.

Preferably the filter element comprises a perforated member and an annular peripheral wall, which can be of a unitary construction. Preferably the perforated member is a disc. In one preferable form the disc is a mesh disc. Preferably the filter element includes a projection at the centre of the disc, of a shape suitable for lifting and/or rotating the disc.

In an alternative arrangement, preferably the perforated member is a basket. Preferably the basket extends beyond the support member and projects into the pipe.

Preferably the closure member is in the form of a plug which comprises a disc with a protrusion to aid the lifting and rotating of the disc and a peripheral wall depending from the disc. Preferably the protrusion is configured so as to prevent engagement thereof by hand for removal and/or rotation of the closure member.

Preferably sealing means are located at the periphery of the filter element and/or at the periphery of the closure member. Preferably the sealing means are an O-ring seal, or the like. Any suitable seal section may be provided, including other shapes of gasket or rings (eg. square, hollow or the like).

Preferably a first locking means is provided for releasably mounting the filter element to the support member. Preferably the first locking means comprises one or more projections on an inner surface of the support member, each projection adapted to cooperate with a corresponding recess in an outer peripheral face of the filter element. Most preferably the corresponding recess is a T-shaped slot. It will be appreciated that the projections and grooves may be disposed on the opposite parts to that described above.

Preferably a second locking means is provided for releasably mounting the closure member to the filter element. Preferably the second locking means comprises on the closure member one or more projections on an outward peripheral face, each projection adapted to cooperate with a corresponding recess in an inner peripheral face of the filter element. Most preferably the corresponding recess is an L-shaped slot. Again the projections may be on the filter member and the recess/slot on the closure member in an alternate arrangement.

In a third aspect the present invention provides a filter and/or closure assembly for use with a pipe, the assembly comprising:
a support member which is adapted in use for connection to and location in the pipe;
a filter element releasably mountable to the support member so as to inhibit the passage of solid material through the pipe; and
a closure member adapted for blocking the pipe;
   wherein the closure member is, defined by a first part of the filter element and is moveable with respect to a second part of the filter element between a closed position in which respective holes in the first and second parts do not align to thereby prevent the passage of fluid, and an open position in which the holes are at least partly aligned to allow the passage of fluid therethrough.

In a fourth aspect the present invention provides a filter and/or closure assembly for use with a pipe, the assembly comprising:
a support member which is adapted in use for connection to and location in the pipe;
a filter element releasably mountable to the support member so as to inhibit the passage of solid material through the pipe; and
a closure member adapted for blocking the pipe;
   wherein the closure member is defined by the filter element when mounted to the support member, the filter element and support member being relatively moveable between a closed position in which respective holes in the support member and the filter element do not align to thereby prevent the passage of fluid, and an open position in which the holes are at least partly aligned to allow the passage of fluid therethrough.

In one form of the filter and/or closure assembly of the third or fourth aspects, the support member can be located wholly within the pipe in use. In a further embodiment, the filter element can also be located wholly within the pipe in use. Such embodiments can present significant difficulties to an operator seeking to tamper with the assembly and trying to access the filter element. The location of at least some of the components of the assembly wholly within the pipe reduces the ease of access thereto.

Preferably the filter assembly of the third and fourth aspects is as otherwise defined in the first and second aspects.

In a fifth aspect the present invention provides a closure assembly for use with a pipe, the assembly comprising:
a support member which is adapted in use for connection to and location wholly within the pipe;
a closure member mountable to the support member for blocking the pipe.

In a sixth aspect the present invention provides a closure assembly for use with a pipe, the assembly comprising:
a support member which in use is operatively connectable to the pipe; and
a closure member mountable to the support member for blocking the pipe;
   wherein the assembly is configured such that in use the support member and the closure member are located wholly within the pipe.

The invention defined in the fifth and sixth aspects presents significant difficulties to an operator seeking to tamper with the assembly and trying to access the closure member. The location of at least some of the components of the assembly wholly within the pipe reduces the ease of access thereto.

Preferably a filter element is releasably mountable to the support member so as to inhibit the passage of solid material through the pipe.

Preferably the filter assembly of the fifth and sixth aspects is as otherwise defined in the first and second aspects.

In a seventh aspect the present invention provides a closure member for use with a closure assembly for a pipe, the closure member comprising a body, and a protrusion from the body or a recess in the body for aiding removal and/or rotation of the body, the protrusion or recess being configured so as to prevent engagement thereof by hand for removal and/or rotation of the body.

Such an arrangement ensures that unauthorised removal of the closure member from the closure assembly by an operator is unlikely unless a specialised tool is made available for this task which gives purchase about the protrusion or internal the recess.

Preferably a specialised tool is required for respective purchase about the protrusion or insertion within the recess, in order to effect removal and/or rotation of the body.

Preferably the closure member of the seventh aspect is as otherwise defined in the first and second aspects.

In an eighth aspect the present invention provides a closure locking arrangement for use with a closure assembly for a pipe, the locking arrangement comprising first and second locking means which cooperate so that as a closure member is rotated to disengage the first locking means and release the closure member from a filter element, the second locking means is caused to engage to prevent removal of the filter element from a support member.

Such an arrangement ensures that during removal of the closure member there is unlikely to be simultaneous and/or inadvertant removal of the filter element from the support member.

Preferably the filter assembly and closure locking arrangement of the eighth aspect are as otherwise defined in the first and second aspects.

In a ninth aspect the present invention provides an assembly for preventing the ingress of unwanted refuse into a pipe during a construction application in or at an area containing the pipe, the assembly comprising:
a support member which is adapted in use for connection to and location in the pipe; and
a closure member mountable to the support member or the filter element for blocking the pipe,
   wherein, during the construction application in or at the area, the closure member is arranged to prevent the ingress of the unwanted refuse into the pipe, and wherein, after the construction application is complete, the closure member is completely removed from the assembly to open the pipe to fluid flow therethrough via the assembly.

In one form the assembly of the ninth aspect can additionally comprise a filter element releasably mountable to the support member so as to inhibit the passage of solid material through the pipe.

Preferably the assembly of the ninth aspect is as otherwise defined in the first and second aspects.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1a shows a plan view of one embodiment of a support member forming part of the apparatus according to the present invention;

FIG. 1b shows a sectional side elevation view of the embodiment of FIG. 1a;

FIG. 2 shows an assembly drawing showing, in sectional view, how the support member of FIGS. 1a and 1b, the filter element of FIGS. 3a, 3b and 3c, and the closure member of FIGS. 4a and 4b fit together to form the assembly of the invention;

FIG. 3a shows a plan view of one embodiment of a filter element forming part of the apparatus according to the present invention;

FIG. 3b shows a sectional side elevation view of the embodiment of FIG. 3a when viewed along line A-A;

FIG. 3c shows a further sectional side elevation view of the embodiment of FIG. 3a when viewed along line A-A;

FIG. 4a shows a plan view of the closure member forming part of apparatus according to the present invention;

FIG. 4b shows a sectional side elevation view of the closure member of FIG. 4a;

FIG. 5a shows a plan view of one embodiment of a support member forming part of the apparatus according to the present invention;

FIG. 5b shows a sectional side elevation view of the support member of FIG. 5a;

FIG. 5c shows a perspective partial view of the support member of FIG. 5a;

FIG. 6a shows a plan view of one embodiment of a filter element forming part of the apparatus according to the present invention;

FIG. 6b shows a sectional side elevation view of the filter element of FIG. 6a;

FIG. 7a shows a plan view of one embodiment of a closure member forming part of the apparatus according to the present invention;

FIG. 7b shows a sectional side elevation view of the closure member of FIG. 7a;

FIG. 8 shows an assembly drawing showing, in sectional view, how the support member of FIGS. 5a, 5b and 5c, the filter element of FIGS. 6a and 6b, and the closure member of FIGS. 7a and 7b fit together to form the assembly of the invention;

FIG. 9 shows an exploded assembly side elevational view of a further embodiment of a filter and/or closure assembly according to the present invention;

FIG. 10 shows a sectional side elevation view of the assembly of FIG. 9 when fitted into a pipe;

FIG. 11 shows a sectional side elevation view of a further embodiment of a filter and/or closure assembly according to the present invention, the assembly fitted into a pipe;

FIG. 12 shows a sectional side elevation view of a further embodiment of a filter and/or closure assembly according to the present invention, the assembly fitted into a pipe;

FIG. 13 shows an exploded assembly side elevational view of a further embodiment of a filter and/or closure assembly according to the present invention;

FIG. 14 shows an exploded assembly side elevational view of a further embodiment of a filter and/or closure assembly according to the present invention;

FIG. 15 shows an exploded assembly side elevational view of a further embodiment of a filter and/or closure assembly according to the present invention;

FIG. 16 shows an exploded assembly side elevational view of a further embodiment of a filter and/or closure assembly according to the present invention;

FIG. 17 shows a detailed view of the closure member of FIGS. 13 and 14 and a tool (not part of the invention) to effect rotational removal of the closure from the assembly;

FIG. 18 shows a side sectional view of one embodiment of a filter and closure assembly according to the present invention;

FIG. 19 shows a plan view of the embodiment of FIG. 18 when the filter and closure is in the open position;

FIG. 20 shows a plan view of the embodiment of FIG. 18 when the filter and closure is in the closed position.

### MODES FOR CARRYING OUT THE INVENTION

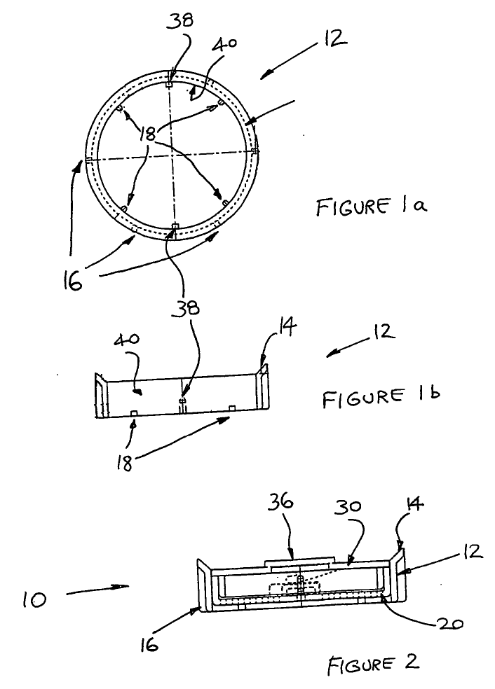

Referring to the drawings, in FIGS. 1a and 1b there is shown a support member of a pipe filter, and closure assembly generally shown as 10, the support member in the form of an annular collar 12 or sleeve having a sloping upper lip 14 and six web flanges 16 which in use protrude outwardly from the collar 12. The lip 14 and webs 16 are arranged to abut the interior surface of a pipe (not shown). The upper lip 14 is sloped at an angle of 45° so that debris flowing through the pipe and the assembly 10 does not build up on the upper end of the collar 12. In use, the collar 12 is positioned wholly within the pipe at some distance from an open (upper) end of the pipe. In this preferred embodiment, the collar 12 has four inwardly protruding support tabs 18 upon which a filter element in the form of a strainer 20 can be seated and supported. These tabs 18 prevent the strainer 20 from falling directly into the pipe.

In use, the collar 12 can be secured in position at the interior wall of the pipe by gluing, or by using fasteners, welding or any other suitable technique. In other preferred embodiments the collar 12 may be releasably secured by catches or pins or similar.

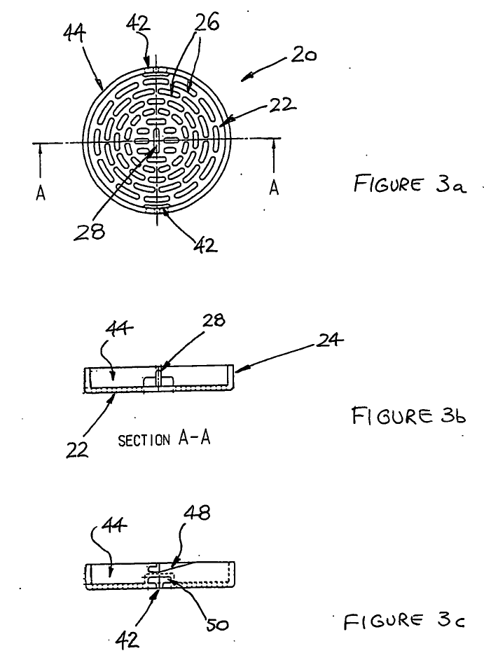

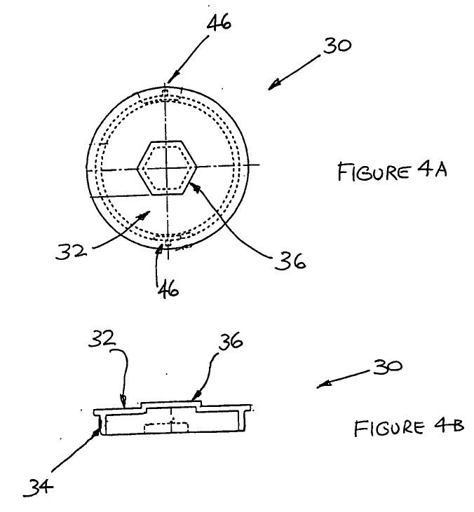

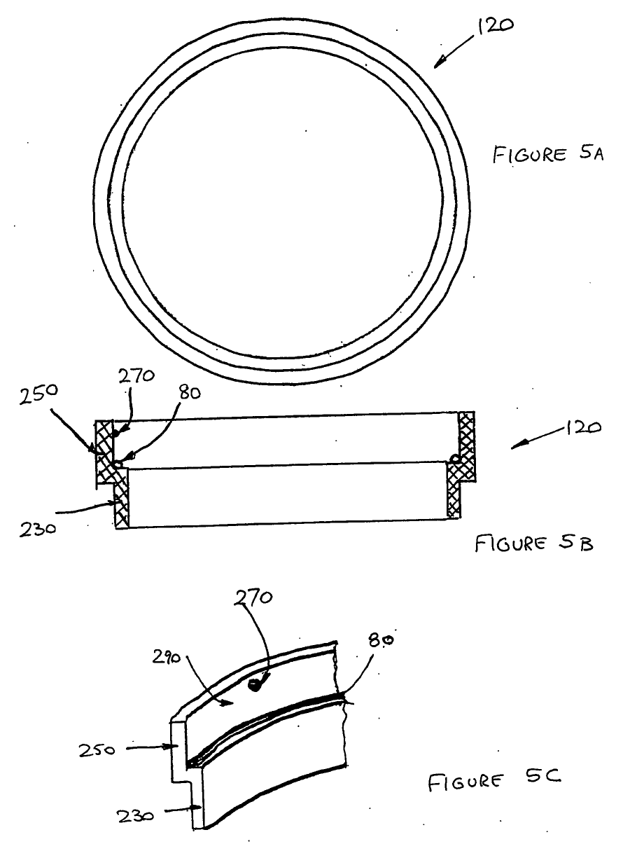

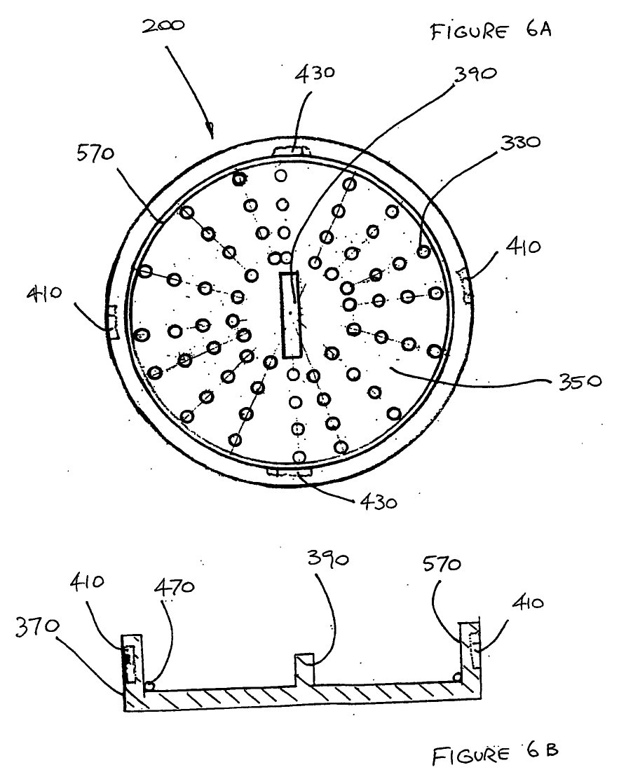

A filter element in the form of a strainer 20 is releasably mountable to the collar 12 so as to inhibit the passage of solid material through the pipe, whilst allowing the passage of fluids (liquids and gases) therethrough. A preferred embodiment of a strainer 20 is shown in FIGS. 3a, 3b and 3c. The strainer 20 comprises a perforated circular disc 22 and an annular peripheral wall 24, which can be of a unitary construction (ie. the disc 22 and the wall 24 can be made of one material). In the illustrated embodiment the circular disc 22 has a series of concentric slots 26 arranged thereabout to allow the passage of fluid therethrough. In another preferred form the circular disc can be made of metal mesh eg. a screen mesh. In the preferred embodiment the strainer 20 includes a rectangular-shaped projection 28 located at the centre of the disc 22 to provide a grip point of a shape suitable for lifting and/or rotating the disc 22. FIGS. 4a and 4b illustrate a closure member in the form of a plug 30 which in use is mountable inside the collar 12 to be seated at the strainer 20. In use when the plug 30 is in place, the flow of material through the pipe is blocked. The plug 30 comprises a disc 32 having an in use downwardly oriented peripheral circumferential wall 34 and an upper surface protrusion in the form of a hexagonal-shaped nut 36 or prism to aid the lifting and rotation of the plug 30 during removal and replacement. However the hexagonal nut 36 has a relatively wide diameter and a relatively low height, for example having a height which is about one tenth of the hexagonal nut diameter. Such an aspect ratio is configured to prevent easy engagement thereof by hand to reduce the incidence of unauthorised tampering unless a specialised tool such as a socket on the end of a rod is made available for this task which gives purchase about the hexagonal nut 36.

An assembly 10 of the collar 12, strainer 20 and plug 30 is shown in FIG. 2. In such a preferred embodiment the assembly 10 is configured so that in use the collar 12, the strainer 20 and the plug 30 are located wholly within the pipe. This is not necessarily the case in other preferred embodiments, although when at least some parts of the apparatus are located wholly within the pipe this reduces the ease of access to and presents significant difficulties for an operator seeking to tamper with the assembly by, for example, trying to open the plug 30 in order to access the strainer 20.

The assembly of parts shown in FIG. 2 is joined together by releasably mounting the strainer 20 to the collar 12 by a first locking means and the plug 30 to the strainer 20 by a second locking means. The first locking means comprises two projecting tabs 38 located on the inner circumferential face 40 of the collar 12, each tab 38 for receipt in a recess in the form of a T-shaped slot 42 located in an outer peripheral face of the strainer wall 24. In further embodiments it will be appreciated that the projections and grooves may be disposed on the opposite parts to that described above. A second locking means is provided for releasably mounting the plug 30 to the strainer 12. The second locking means comprises two projecting tabs 46 located on the outward peripheral face of the plug 30, each tab 46 adapted to cooperate with a corresponding L-shaped slot 48 in an inner peripheral face 44 of the strainer 20. Again the projecting tabs may be on the strainer and the recess/slot on the plug in an alternate arrangement. The L-shaped slot 48 is arranged with a sloping entryway for guiding a corresponding tab 46 in and out thereof, the entryway typically arranged with a slope of 15 angle degrees.

The operation of the first and second locking means will now be outlined. To join the assembly parts together, the collar 12 is affixed or otherwise placed into the pipe and the two tabs 38 located on the inner circumferential wall 40 are each guided into the basal portion of a respective T-shaped slot 42 of the strainer 20. The strainer 20 is then rotated so that the tabs 38 are moved into a position to abut the ends of the upper slot 50 of the T-bar. The plug 30 is then seated on the strainer 20 and the projecting tabs 46 are each guided down into the sloping entryway of the L-shaped slots 48 located in the inner peripheral face 44 of the strainer 20 as the plug 30 is rotated.

When the plug 30 is to be removed from the strainer 20 by rotation of the plug 30 in the reverse direction, the first and second locking means cooperate so that if any frictional forces etc inadvertently cause the strainer 20 to rotate in the same direction as the plug 30, respective tabs 38 are moved into a position to abut the respective opposing ends of the upper slot 50 of the T-bar, which ultimately restrains any further rotation of the strainer 20 relative to the collar 12 and ensures that the strainer 20 is not accidentally removed. Not only does this prevent any tampering with the strainer 20, this also avoids the accidental discharge of solid matter etc.

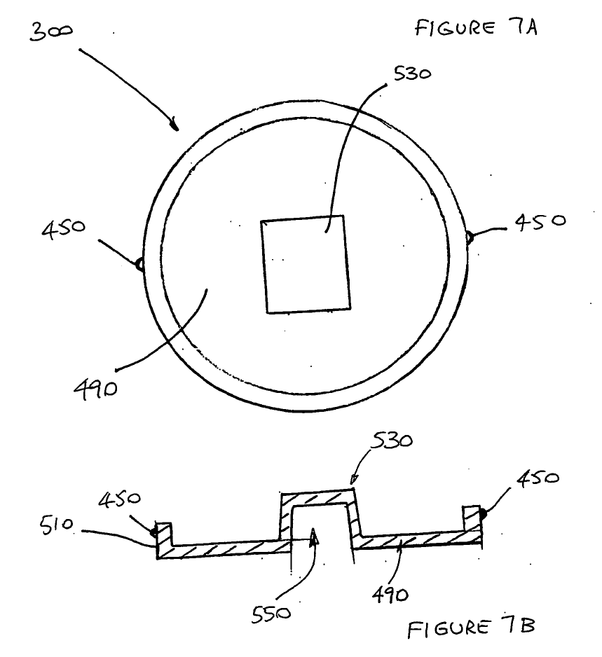

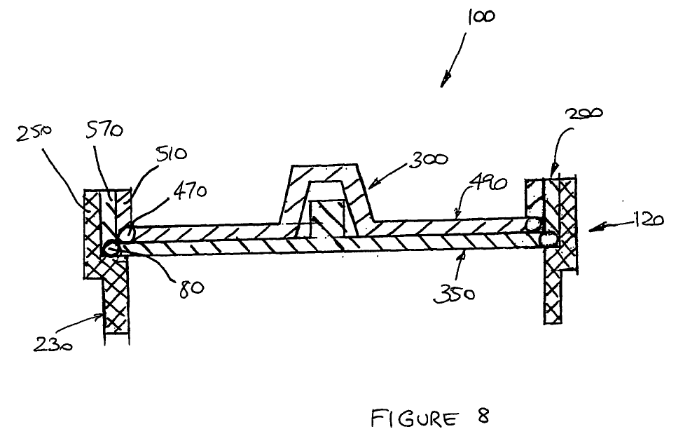

Referring now to FIGS. 5 to 8, there is shown a pipe filter and closure apparatus generally indicated at 100 (FIG. 8) and including a support member in the form of a collar 120, a filter element in the form of a strainer 200, and a closure member in the form of a plug 300. O-ring gaskets to provide a fluid tight seal are also shown 80.

The collar 120 comprises a first collar section 230 and a second collar section 250, the latter outwardly disposed and fixed generally to the top of the first collar section 230. A projection 270 is affixed to the inside peripheral wall 290 of the second collar section 250. This projection 270 assists the locking of the strainer 200 in place. Disposed at the inner junction defining a shoulder between the two collar sections 230, 250 is an O-ring 80, in use which ensures that material only passes through the perforations 330 of the strainer 200 and not between the in use adjacent walls of the collar 120 and strainer 200.

The filter element is in the form of a strainer 200 and comprises a disc body 350 with perforations 330, a peripheral wall 370 projecting upwards, and a handle 390 to assist removal and locking. Located in the outside face of the peripheral wall 370 are L-shaped grooves 410, disposed to receive the projection 270 and thus lock the strainer 200 in position. Further L-shaped grooves 430 are located in the inner face of peripheral wall 370, disposed to receive projections 450 on the plug 300. Located at the peripheral wall 370 and disc 350 interface is an O-ring 470, for sealing, in conjunction with the plug 300.

The plug 300 comprises a disc 490, peripheral wall 510, central handle 530, void 550 and projection 450. The void 550 is located underneath the handle 530 to accommodate the handle 390 on the strainer 200. Thus, the respective discs 490, 350 of plug 300 and strainer 200 fit snugly against each other when installed. The projection 450 is disposed to slide within the further L-shaped grooves 430 on the peripheral wall 570 of strainer 200. This provides locking of the plug 300 in position.

In use the collar 120 is placed in or at the entrance to a pipe. The L-shaped grooves 410 on the strainer 200 are aligned with the projections 270 on the inner peripheral face 290 of the collar 120, and the strainer 200 is placed inside the collar 120, resting on the seal 80. The strainer 200 may then be rotated and locked in position.

The plug 300 may be attached, again aligning the projections 450 with the L-shaped grooves 430 in the peripheral wall 570 of the strainer 200, and rotating and locking the plug 300 in position if desired.

Several other embodiments within the scope of the invention will now be described with reference to the drawings. Where like parts are referred to as shown in the embodiment shown in FIGS. 1-4, similar part numbers are used for ease of reference.

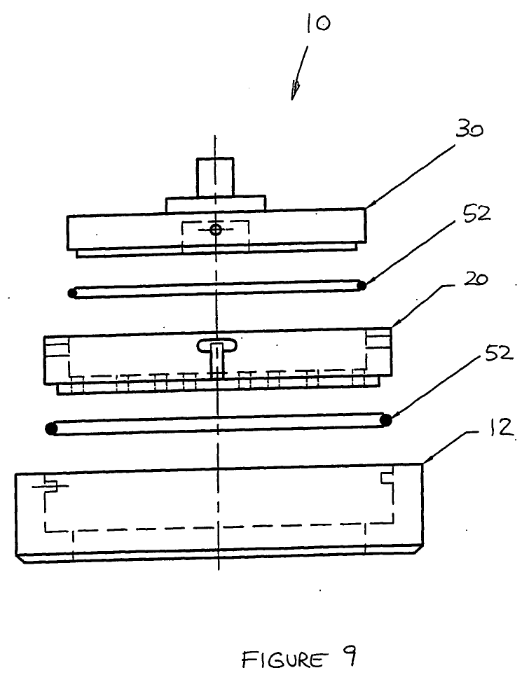

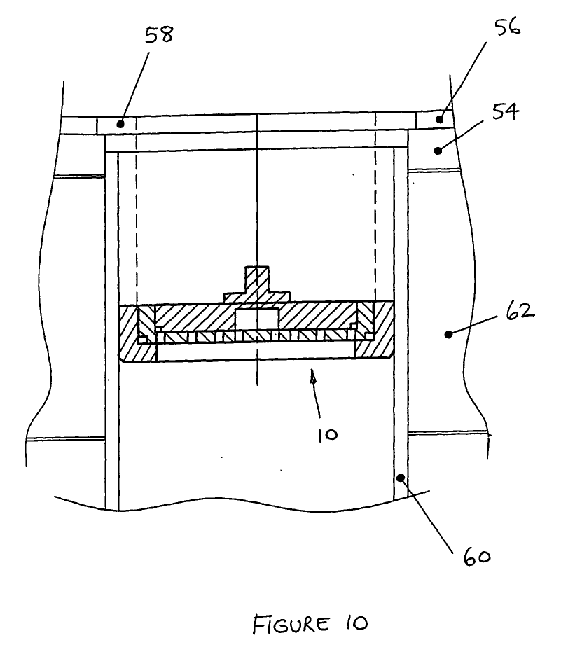

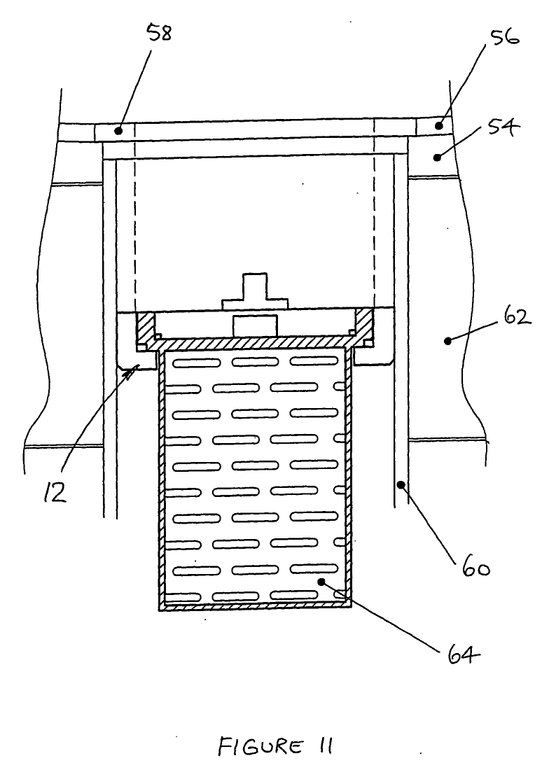

Referring now to the embodiment shown in FIGS. 9 and 10, a filter and/or closure assembly is shown in which O-ring type gaskets 52 are positioned between the plug 30, strainer 20 and collar 12 parts. These parts are joined by the tab-in-slot arrangements already described in relation to earlier embodiments. The assembly of this embodiment is shown fitted to a pipe 60 in FIG. 10 and is located wholly within the pipe 60 and at a position remote from the end of the pipe 60. The pipe 60 is located to pass through a concrete slab 62 which has a mortar bed 54 and a tiled floor 56 thereabove. A commercially available floor waste fitting 58 is located at the end of the pipe 60 at tiled floor level.

In an alternative arrangement shown in FIG. 11, the strainer is in the form of a slotted catchment basket 64 and the basket 64 extends beyond the collar 12 and projects into the pipe 60. Such a basket shape provides a greater volume for collection of debris which is useful in some situations where a great deal of solid matter may be present at the building, industrial or construction site above.

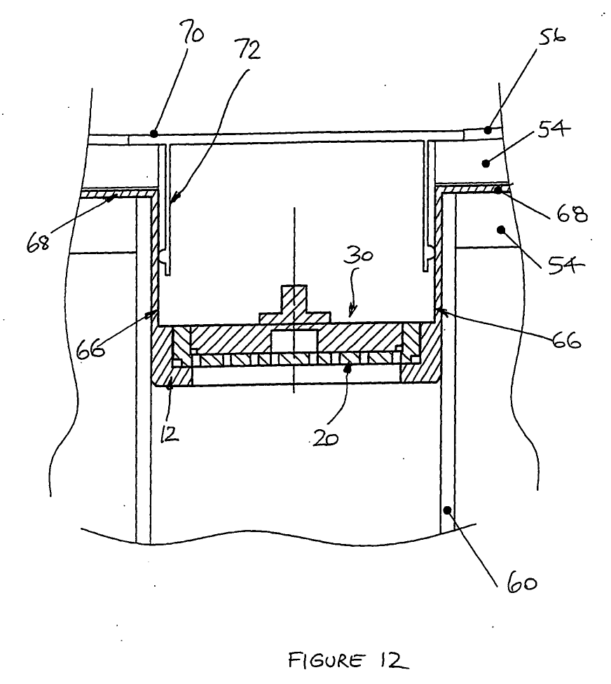

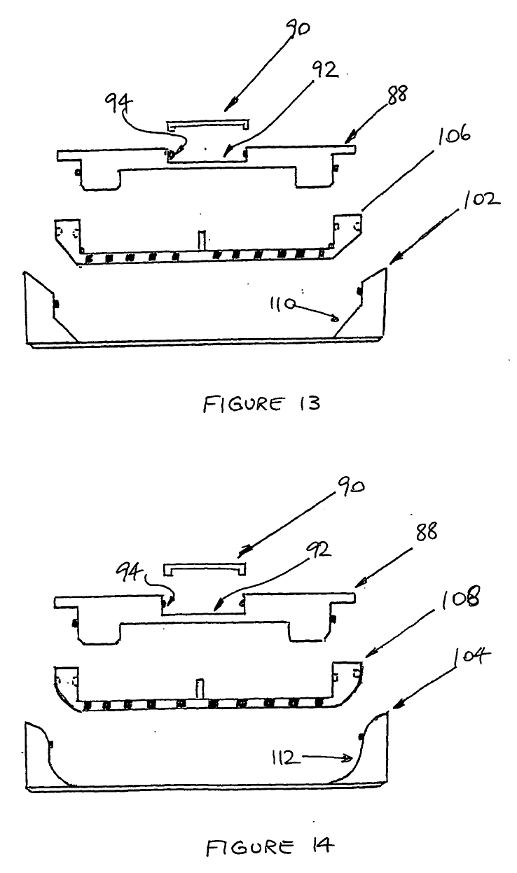

In FIG. 12 the filter assembly shown includes the previously described collar, strainer and plug assembly shown in FIGS. 9 and 10, however in this embodiment the collar 12 is formed at one end of an annular sleeve 66. The sleeve 66 has an orthogonal flange 68 located at the sleeve end nearest the floor surface and away from the strainer and plug end of the assembly. In this embodiment the collar 12 need not be fastened or glued to the interior of the pipe 60 but can be suspended and retained therein by the sleeve 66 and flange 68. The spacing of the collar section away from the uppermost end of the pipe serves to allow the insertion of a commercial floor waste fitting 70 which has elongate fastening tabs 72 which are arranged to project into the pipe 60. While the strainer 20 is located wholly within the pipe 60, in this instance the support member (which includes the collar 12, the sleeve 66 and the flange 68) is not. In a further embodiment, it is also envisaged that the collar can be connected to and located wholly within the pipe whereas the strainer may be of a shape which is not confined within the pipe. For example, the strainer may be seated at the collar but may extend upward to the end of the pipe and have flanges which protrude out from the pipe end.

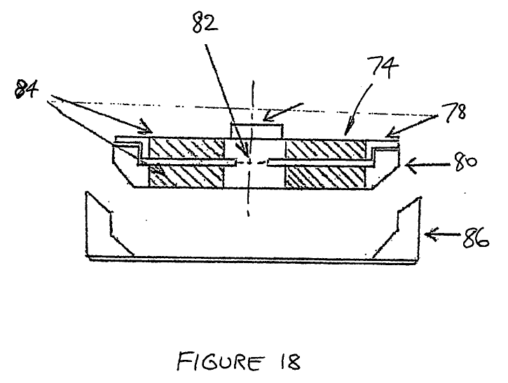

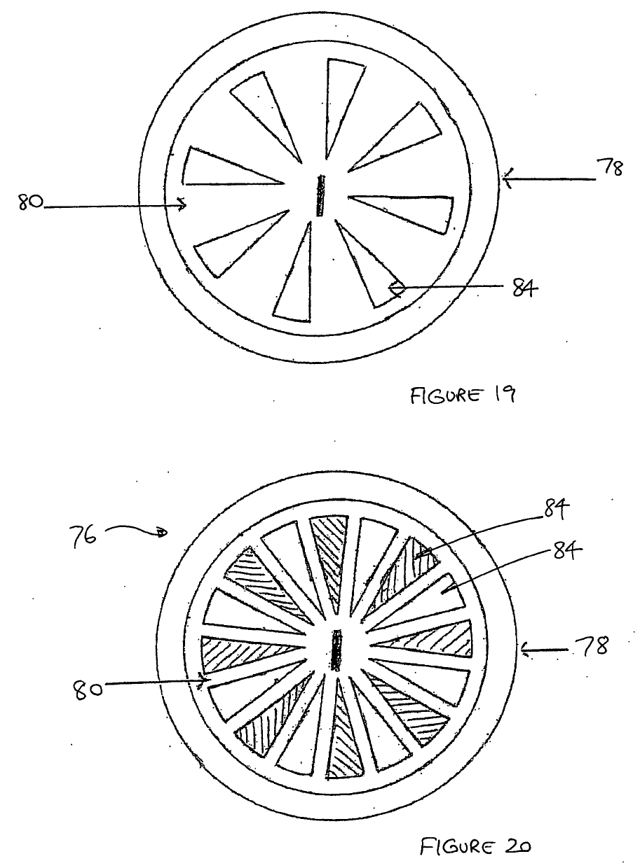

In still further embodiments the plug can be mountable to the collar or strainer (as shown in previous embodiments), or defined as part of the filter or the support element. For example in FIGS. 18 to 20 the strainer 74 can also function as a plug 76, obviating the need for a separate plug. As shown in FIG. 18 the strainer 74 comprises two adjacent and concentric discs 78, 80, rotatably moveable with respect to each other about a pivot point 82. In the closed position in which respective triangular holes 84 in the first and second discs 78, 80 are out of alignment (FIG. 20), the passage of fluid is prevented. In the open position (FIG. 19) the holes 84 are aligned to allow the passage of fluid therethrough. The strainer discs 78, 80 and the collar 86 to which they are mounted in use is wholly located within the pipe.

In an alternative embodiment such a closure can be achieved by relative rotation (or other movement) between the strainer when mounted to a support element of a different form to the collar previously described. For example, the support element in this case can be a perforated plate. Once again in such an embodiment, the strainer and the perforated plate are relatively moveable between a closed position in which respective holes in each do not align to thereby prevent the passage of fluid, and an open position in which the holes are at least partly aligned to allow the passage of fluid therethrough.

In still further embodiments of the invention there may be no need for a strainer at all. In such cases the closure assembly can comprise a collar adapted for connection to and location wholly within the pipe and a plug mountable thereto. Because the collar is adapted for connection to the interior of the pipe, its position is variable, and can be adjusted upon installation to make tampering with the associated plug difficult.

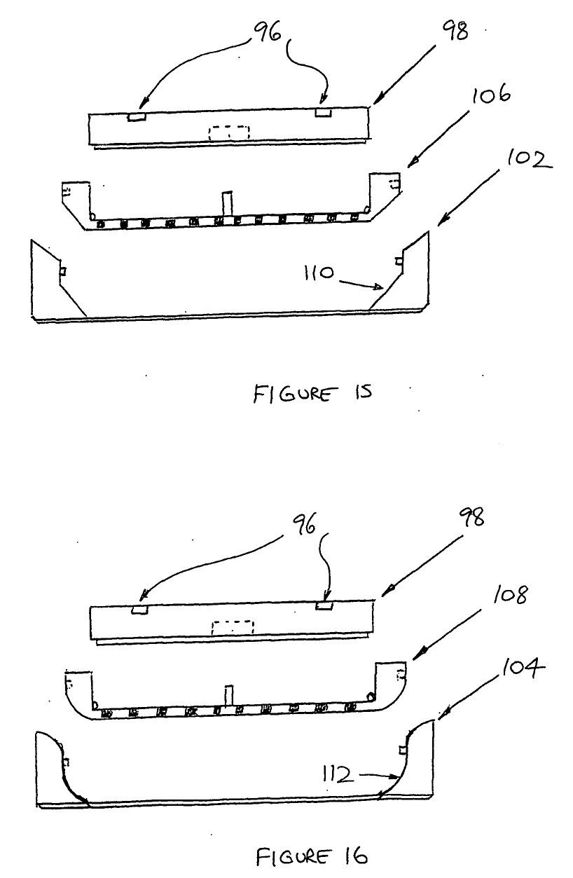

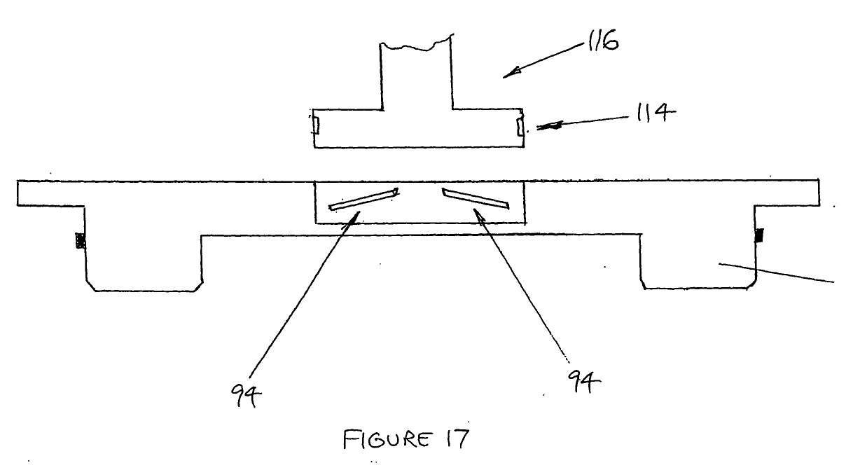

Turning to FIGS. 13-16, in each embodiment the plug 88, 98 has an uppermost recess or recesses for aiding the removal and/or the rotation of the plug 88, 98. In FIGS. 13 and 14 a removeable protective cap 90 conceals a recess 92 fitted with protruding lugs 94 which are engageable with a specialist tool operated by a user. As an example, in FIG. 17 a tool 116 is shown having recesses 114 for engagement in use with the lugs 94 located in the recess 92 of the plug 98 to enable turning of the plug 98. In FIGS. 15 and 16 there are two spaced apart recesses 96 in the uppermost surface of the plug 98 into which a tool with dual arms can be inserted to provide a torsional force to rotate the plug 98. Such arrangements ensure that unauthorised removal of the closure member from the closure assembly by an operator is unlikely unless a specialised tool is made available for this task which locates into these recesses 96.

FIGS. 13-16 also show a support member in the form of a collar 102, 104 which has various angled and curved innermost faces 110, 112 for abutting and supporting an inserted strainer 106, 108 from falling into a pipe to which the assembly is fitted.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

1-39. (canceled)

40. A filter and/or closure assembly for use with a pipe, the assembly comprising:
a support member which is adapted in use for connection to and location wholly within the pipe;
a filter element releasably mountable to the support member so as to inhibit the passage of solid material through the pipe; and
a closure member mountable to the support member or the filter element for blocking the pipe.

41. A filter and/or closure assembly as claimed in claim 40 wherein the support member is adapted for connection around its periphery to the pipe interior, to be located remote from an end of the pipe.

42. A filter and/or closure assembly as claimed in claim 41 wherein the support member is a collar.

43. A filter and/or closure assembly as claimed in claim 40 wherein the support member comprises first and second collar sections of different diameter and which are disposed in end-to-end adjoinment with one another.

44. A filter and/or closure assembly as claimed in claim 43 wherein a support shoulder is formed at an inner wall of the adjoining collar sections, in use to support the filter element.

45. A filter and/or closure assembly as claimed in claim 40 wherein the filter element comprises a perforated member and an annular peripheral wall.

46. A filter and/or closure assembly as claimed in claim 45 wherein the perforated member is at least one of a mesh disc or a basket.

47. A filter and/or closure assembly as claimed in claim 46 wherein the filter element includes a projection at the centre of the disc, of a shape suitable for lifting and/or rotating the disc.

48. A filter and/or closure assembly as claimed in claim 46 wherein the basket extends beyond the support member and projects into the pipe.

49. A filter and/or closure assembly as claimed in claim 40 wherein the closure member is in the form of a plug which comprises a disc with a protrusion to aid the lifting and rotating of the disc and a peripheral wall depending from the disc.

50. A filter and/or closure assembly as claimed in claim 49 wherein the protrusion is configured so as to prevent engagement thereof by hand for removal and/or rotation of the closure member.

51. A filter and/or closure assembly as claimed in claim 40 wherein sealing means are located at the periphery of the filter element and/or at the periphery of the closure member.

52. A filter and/or closure assembly as claimed in claim 51 wherein the sealing means are an O-ring seal, or the like.

53. A filter and/or closure assembly as claimed in claim 40 wherein a first locking means is provided for releasably mounting the filter element to the support member.

54. A filter and/or closure assembly as claimed in claim 53 wherein the first locking means comprises one or more projections on an inner surface of the support member, each projection adapted to cooperate with a corresponding recess in an outer peripheral face of the filter element.

55. A filter and/or closure assembly as claimed in claim 54 wherein the corresponding recess is a T-shaped slot.

56. A filter and/or closure assembly as claimed in claim 40 wherein a second locking means is provided for releasably mounting the closure member to the filter element.

57. A filter and/or closure assembly as claimed in claim 56 wherein the second locking means comprises on the closure member one or more projections on an outward peripheral face, each projection adapted to cooperate with a corresponding recess in an inner peripheral face of the filter element.

58. A filter and/or closure assembly as claimed in claim 57 wherein the corresponding recess is an L-shaped slot.

59. A filter and/or closure assembly for use with a pipe, the assembly comprising:
a support member which in use is operatively connectible to the pipe;
a filter element releasably mountable to the support member so as to inhibit the passage of solid material through the pipe; and
a removable closure member mountable to the support member or the filter element for blocking the pipe,
wherein the assembly is configured such that in use the filter element and the closure member are located wholly within the pipe.

60. A filter and/or closure assembly as claimed in claim 59 wherein the support member is adapted for connection around its periphery to the pipe interior, to be located remote from an end of the pipe.

61. A filter and/or closure assembly as claimed in claim 60 wherein the support member is a collar.

62. A filter and/or closure assembly as claimed in claim 59 wherein the filter element comprises a perforated member and an annular peripheral wall.

63. A filter and/or closure assembly as claimed in claim 62 wherein the perforated member is at least one of a mesh disc or a basket.

64. A filter and/or closure assembly as claimed in claim 63 wherein the filter element includes a projection at the centre of the disc, of a shape suitable for lifting and/or rotating the disc.

65. A filter and/or closure assembly as claimed in claim 59 wherein the closure member is in the form of a plug which comprises a disc with a protrusion to aid the lifting and rotating of the disc and a peripheral wall depending from the disc.

66. A filter and/or closure assembly as claimed in claim 65 wherein the protrusion is configured so as to prevent engagement thereof by hand for removal and/or rotation of the closure member.

67. A filter and/or closure assembly as claimed in claim 59 wherein sealing means are located at the periphery of the filter element and/or at the periphery of the closure member.

68. A filter and/or closure assembly as claimed in claim 59 wherein a first locking means is provided for releasably mounting the filter element to the support member.

69. A filter and/or closure assembly as claimed in claim 68 wherein the first locking means comprises one or more projections on an inner surface of the support member, each projection adapted to cooperate with a corresponding recess in an outer peripheral face of the filter element.

70. A filter and/or closure assembly as claimed in claim 59 wherein the corresponding recess is a T-shaped slot.

71. A filter and/or closure assembly as claimed in claim 50 wherein a second locking means is provided for releasably mounting the closure member to the filter element.

72. A filter and/or closure assembly as claimed in claim 71 wherein the second locking means comprises on the closure member one or more projections on an outward peripheral face, each projection adapted to cooperate with a corresponding recess in an inner peripheral face of the filter element.

73. A filter and/or closure assembly as claimed in claim 72 wherein the corresponding recess is an L-shaped slot.

74. A filter and/or closure assembly for use with a pipe, the assembly comprising:
a support member which is adapted in use for connection to and location in the pipe;
a filter element releasably mountable to the support member so as to inhibit the passage of solid material through the pipe; and
a closure member adapted for blocking the pipe;
wherein the closure member is defined by a first part of the filter element and is moveable with respect to a second part of the filter element between a closed position in which respective holes in the first and second parts do not align to thereby prevent the passage of fluid, and an open position in which the holes are at least partly aligned to allow the passage of fluid therethrough.

75. A filter and/or closure assembly as claimed in claim 74 wherein the support member is located wholly within the pipe in use.

76. A filter and/or closure assembly as claimed in claim 75 wherein the filter element is also located wholly within the pipe in use.

77. A filter and/or closure assembly for use with a pipe, the assembly comprising:
a support member which is adapted in use for connection to and location in the pipe;
a filter element releasably mountable to the support member so as to inhibit the passage of solid material through the pipe; and
a closure member adapted for blocking the pipe;
wherein the closure member is defined by the filter element when mounted to the support member, the filter element and support member being relatively moveable between a closed position in which respective holes in the support member and the filter element do not align to thereby prevent the passage of fluid, and an open position in which the holes are at least partly aligned to allow the passage of fluid therethrough.

78. A filter and/or closure assembly as claimed in claim 77 wherein the support member is located wholly within the pipe in use.

79. A filter and/or closure assembly as claimed in claim 78 wherein the filter element is also located wholly within the pipe in use.

80. A closure assembly for use with a pipe, the assembly comprising:
a support member which is adapted in use for connection to and location wholly within the pipe;
a closure member mountable to the support member for blocking the pipe.

81. A closure assembly as claimed in claim 80 further comprising a filter element releasably mountable to the support member so as to inhibit the passage of solid material through the pipe.

82. A closure assembly for use with a pipe, the assembly comprising:
a support member which in use is operatively connectible to the pipe; and
a closure member mountable to the support member for blocking the pipe;
wherein the assembly is configured such that in use the support member and the closure member are located wholly within the pipe.

83. A closure assembly as claimed in claim 82 further comprising a filter element releasably mountable to the support member so as to inhibit the passage of solid material through the pipe.

84. A closure member for use with a closure assembly for a pipe, the closure member comprising a body, and a protrusion from the body or a recess in the body for aiding removal and/or rotation of the body, the protrusion or recess being configured so as to prevent engagement thereof by hand for removal and/or rotation of the body.

85. A closure member as claimed in claim 84 wherein a specialised tool is required for respective purchase about the protrusion or insertion within the recess, in order to effect removal and/or rotation of the body.

86. A closure assembly as claimed in claim 84 wherein the assembly is as otherwise defined in claim 40.

87. A closure locking arrangement for use with a closure assembly for a pipe, the locking arrangement comprising first and second locking means which cooperate so that as a closure member is rotated to disengage the first locking means and release the closure member from a filter element, the second locking means is caused to engage to prevent removal of the filter element from a support member.

88. A closure assembly as claimed in claim 87 wherein the assembly is as otherwise defined in claim 40.

89. An assembly for preventing the ingress of unwanted refuse into a pipe during a construction application in or at an area containing the pipe, the assembly comprising:
a support member which is adapted in use for connection to and location in the pipe; and
a closure member mountable to the support member or the filter element for blocking the pipe,
wherein, during the construction application in or at the area, the closure member is arranged to prevent the ingress of the unwanted refuse into the pipe, and wherein, after the construction application is complete, the closure member is completely removed from the assembly to open the pipe to fluid flow therethrough via the assembly.

90. An assembly as claimed in claim 89 wherein the assembly additionally comprises a filter element releasably mountable to the support member so as to inhibit the passage of solid material through the pipe.
